(19) United States
(12) Patent Application Publication
(10) Pub. No.: US 2018/0298275 A1
(43) Pub. Date: Oct. 18, 2018

(54) Use of Food Grade Particulates to Form Fractures Having Increased Porosity and Conductivity

(71) Applicant: Halliburton Energy Services Inc., Houston, TX (US)

(72) Inventors: Philip D. Nguyen, Houston, TX (US); Shoy George Chittattukara, Thrissur, Kerala (IN); Ragi Poyyara, Pune, MH (IN)

(21) Appl. No.: 15/761,338

(22) PCT Filed: Oct. 23, 2015
(86) PCT No.: PCT/US15/57221

§ 371 Date: Mar. 19, 2018

(51) Int. Cl. C09K 8/80; C09K 8/60; E21B 43/267

(52) U.S. Cl. CPC C09K 8/805; C09K 2208/26; E21B 43/267; C09K 8/601

(57) ABSTRACT

A method of fracturing a subterranean formation penetrated by a wellbore surrounded by a casing having one or more openings therein adjacent to the formation is provided. In one embodiment, a spacer fluid is pumped into the formation together with a proppant slurry to separate and space the non-degradable proppant particulates in the fracture. The spacer fluid includes degradable food grade particulates that degrade and form proppant free channels in the fracture. In a second embodiment, degradable food grade particulates are used to increase the permeability of a proppant pack.

### BACKGROUND

In order to efficiently produce hydrocarbons from a subterranean formation, the formation must be sufficiently conductive in order to allow the hydrocarbons to flow to the wellbore. Various treatments for increasing the conductivity of a subterranean formation have been developed.

One technique for increasing the conductivity of a subterranean formation and thereby stimulating production of hydrocarbons from the formation is hydraulic fracturing. Hydraulic fracturing generally involves pumping a treatment fluid (for example, a fracturing fluid or a “pad” fluid) into the wellbore at a sufficient hydraulic pressure to create or enhance one or more fractures in the formation. The fracturing fluid typically includes a plurality of non-degradable particulates, often referred to as “proppant particulates,” which are deposited in the fracture in order to prevent the fracture from fully closing once the hydraulic pressure is released and the fracturing operation is complete.

The resulting “propped fracture” provides a conductive channel through which fluids in the formation can flow to the wellbore. The extent to which the conductivity of the formation is increased depends, in part, on the permeability and width of the propped fracture. As used herein and in the appended claims, the term “propped fracture” means a fracture (naturally-occurring or otherwise) in a subterranean formation that contains a plurality of proppant particulates.

In order to enhance the effectiveness of the proppant particulates in propping open the fracture and prevent the proppant particulates from flowing back into the wellbore, the proppant particulates are typically consolidated into a proppant pack within the fracture. For example, the proppant particulates can be coated with a consolidating agent such as a curable resin prior to being placed in the fracture. The curable resin is then caused or allowed to cure in the fracture, which consolidates proppant particulates into a proppant pack and helps keep the particulates in the fracture. As used herein and in the appended claims, the term “proppant pack” refers to a collection of proppant particulates consolidated together within a fracture.

The degree of success of a fracturing operation also depends, at least in part, upon the porosity and conductivity of the fracture once the fracturing operation is ceased and production is initiated. In order to ensure that the porosity and conductivity of the fracture are maintained at sufficient levels, the permeability of the proppant pack formed within the fracture must be considered. For example, a proppant pack that has a low permeability can choke the flow path of fluids through the fracture.

One technique that has been used to help ensure that the porosity and conductivity of the fracture are maintained once the fracturing operation is complete entails the incorporation of a removable component into the proppant pack. For example, a self-degradable polylactic acid (a “PLA Polymer”), acid degradable calcium carbonate or oil soluble resin can be included in the fracturing fluid or proppant slurry in a manner that causes the component to become a part of the proppant pack. After the proppant pack is formed, a solvent or other fluid can be added to the wellbore to dissolve or wash the removable component out of the proppant pack thereby increasing the permeability of the proppant pack.

Another technique that has been used to maintain the porosity and conductivity of the fracture entails the formation of “proppant free channels” in the fracture. For example, a substantially solids free fluid can be pumped into the formation simultaneously with the pumping of proppant particulates into the formation. As a result, a plurality of spaced, consolidated proppant pillars is formed in the fracture. The substantially solids free fluid functions to separate and space the proppant pillars and thereby form substantially proppant free channels in the fracture. The proppant free channels serve as conductive channels through which produced fluids may flow.

### BRIEF DESCRIPTION OF THE DRAWINGS

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

FIG. 1 is a diagram illustrating an example of a fracturing system that can be used in accordance with certain embodiments of the present disclosure.

FIG. 2 is a diagram illustrating an example of a subterranean formation in which a fracturing operation can be performed in accordance with certain embodiments of the present disclosure.

FIG. 3 illustrates one stage of a first embodiment of the disclosed method of fracturing a subterranean formation penetrated by a wellbore surrounded by a casing having one or more openings therein adjacent to the formation.

FIG. 4 illustrates the embodiment of the disclosed method shown in FIG. 3, but at a later stage of the method.

FIG. 5 illustrates a second embodiment of the disclosed method of fracturing a subterranean formation penetrated by a wellbore surrounded by a casing having one or more openings therein adjacent to the formation wherein a proppant pack has been formed in a fracture created in the formation.

FIG. 6 illustrates the proppant pack shown by FIG. 5 after the method is complete.

### DETAILED DESCRIPTION

The present disclosure may be understood more readily by reference to this detailed description as well as to the examples included herein. For simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts have been exaggerated to better illustrate details and features of the present disclosure.

In accordance with this disclosure, a method of fracturing a subterranean formation is provided. The subterranean formation is penetrated by a wellbore having a casing comprising one or more openings therein adjacent to the formation.

In carrying out the disclosed method, for example, tubing such as a coiled tubing (or joint pipes) can be extended from the surface to a point in the wellbore that is adjacent to perforations or openings in the casing that communicate with the formation to be fractured. The diameter of the tubing is smaller than the diameter of the wellbore. As a result, an annulus is created in the wellbore between the tubing and the casing. In this manner, both the tubing and the annulus between the tubing and the casing can be used for the injection of fluids into the formation in carrying out the fracturing treatment. If the contemporaneous injection of separate fluids in not required, for example, as in the second embodiment of the method disclosed below, then tubing such as coiled tubing (or joint pipes) may not be necessary in carrying out the fracturing treatment.

In a first embodiment, the method disclosed herein comprises the following steps:
(a) creating at least one fracture in the formation by pumping a fluid into the formation at a pressure above the fracture gradient of the formation;
(b) providing an aqueous based proppant slurry, the proppant slurry including water, a cross-linkable gelling agent, a cross-linker, a gel breaker and a plurality of non-degradable proppant particulates, the non-degradable proppant particulates being coated with a consolidating agent;
(c) pumping the proppant slurry into the formation at a pressure above the fracture gradient of the formation such that the cross-linking gelling agent cross-links to form a cross-linked gel and increase the viscosity of the proppant slurry, and the proppant slurry is placed in the fracture;
(d) providing a cross-linkable, degradable spacer fluid, the spacer fluid including water, a cross-linkable gelling agent, a cross-linker, a gel breaker, and a degradable material, the degradable material including a plurality of degradable food grade particulates;
(e) while pumping the proppant slurry into the formation in accordance with step (c), pumping the spacer fluid into the formation at a pressure above the fracture gradient of the formation such that the cross-linkable gelling agent cross-links to form a cross-linked gel and increase the viscosity of the spacer fluid, and the spacer fluid separates and spaces the non-degradable proppant particulates within the fracture;
(f) allowing the cross-linked gel in the proppant slurry and spacer fluid to break down thereby decreasing the viscosity of the proppant slurry and spacer fluid;
(g) allowing the non-degradable proppant particulates to consolidate into a plurality of spaced proppant pillars in the fracture;
(h) allowing the pressure within the fracture to fall below the fracture gradient of the formation;
(i) allowing the degradable material to degrade; and
(j) flowing back the well to remove the broken gels in the proppant slurry and spacer fluid and the degraded material from the fracture thereby forming proppant-free channels in the fracture.

In a second embodiment, the method disclosed herein comprises the following steps:
(a) creating at least one fracture in the formation by pumping a fluid into the formation at a pressure above the fracture gradient of the formation;
(b) providing an aqueous based proppant slurry, the proppant slurry including water, a cross-linkable gelling agent, a cross-linker, a gel breaker, a plurality of non-degradable proppant particulates, and a degradable material, the non-degradable proppant particulates being coated with a consolidating agent, and the degradable material including a plurality of degradable food grade particulates;
(c) pumping the proppant slurry into the formation at a pressure above the fracture gradient of the formation such that the cross-linking gelling agent cross-links to form a cross-linked gel and increase the viscosity of the proppant slurry, and the proppant slurry is placed in the fracture;
(d) allowing the cross-linked gel to break down thereby decreasing the viscosity of the proppant slurry;
(e) allowing the non-degradable proppant particulates in the proppant slurry to consolidate into a proppant pack in the fracture;
(f) allowing the pressure within the fracture to fall below the fracture gradient of the formation;
(g) allowing the degradable material of the proppant slurry to degrade; and
(h) flowing back the well to remove the broken gel in the proppant slurry and the degraded material from the fracture thereby increasing the permeability of the proppant pack.

A fracture can be created in the formation in accordance with both embodiments of the disclosed method by pumping a fluid into the formation at a pressure above the fracture gradient of the formation in any manner known to those skilled in the art of fracturing subterranean formations. As used herein and in the appended claims, the fracture gradient of a formation means the minimum pressure required to create a fracture in the formation. Creating a fracture means forming a new fracture or expanding an existing fracture in some dimension in the formation.

For example, once the tubing is inserted to the desired depth, a first fracturing fluid or “pad fluid” can be pumped through the annulus between the tubing and casing and through the openings in the casing into the formation. The first fracturing fluid is pumped into the formation at a pressure above the fracture gradient of the formation in order to create a fracture in the formation. The first fracturing fluid does not typically contain proppant particulates or degradable particulate material. It is used to keep the fracture open until the hydraulic pressure it provides can be provided by another fluid.

In the second embodiment of the disclosed method, although they can be used, separate points of fluid injection such as the tubing and annulus between the tubing and casing are not necessary. For example, the first fracturing fluid and subsequently the proppant slurry can be used to create and maintain the fracture by pumping the fluids directly into the wellbore as a whole and through the openings in the casing into the formation. Alternatively, the proppant slurry alone can be used to create and maintain the fracture by pumping the slurry directly into the wellbore as a whole and through the openings in the casing into the formation.

The aqueous based proppant slurry provided in accordance with both embodiments of the disclosed method can be formed on the site of the wellbore including on the fly as it is pumped into the wellbore as the fracturing treatment is carried out. The water of the aqueous based proppant slurry can come from a variety of sources. For example, the water can be fresh water, brine salt water, seawater, brackish water, formation water, treated flowback water, and mixtures thereof. Additional components can be included in the proppant slurry as will be known to those skilled in the art with the benefit of this disclosure.

The non-degradable proppant particulates of the aqueous based proppant slurry provided in accordance with both embodiments of the disclosed method can be any type of non-degradable proppant particulate suitable for use in forming propped fractures in subterranean formations as known to those skilled in the art. As used herein and in the appended claims, the term “non-degradable proppant particulates” means conventional proppant particulates that when consolidated to prop open a fracture generally retain their structure and integrity for a length of time sufficient to allow hydrocarbons in the formation to be produced through the fracture.

Examples of non-degradable proppant particulates include sand (for example natural sand), fly ash, silica flour, walnut hulls (for example, ground walnut hulls), resin pre-coated proppant particulates such as resin pre-coated sand, man-made non-degradable proppant particulates, and mixtures thereof. Examples of man-made non-degradable proppant particulates include bauxite, ceramics, and polymeric composite particulates. For example, the non-degradable proppant particulates of the aqueous based proppant slurry disclosed herein can be selected from the group of sand, fly ash, silica flour, walnut hulls, resin pre-coated proppant particulates, man-made non-degradable proppant particulates, and mixtures thereof. For example, the non-degradable proppant particulates of the aqueous based proppant slurry disclosed herein can be selected from the group of sand, walnut hulls, resin pre-coated proppant particulates, man-made non-degradable proppant particulates, and mixtures thereof. For example, the non-degradable proppant particulates of the aqueous based proppant slurry disclosed herein can be natural sand.

For example, the non-degradable proppant particulates used in the aqueous based proppant slurry can have a mesh size in the range of from about 4 to about 100 (U.S. Standard Mesh). For example, the non-degradable proppant particulates used in the aqueous based proppant slurry can have a mesh size in the range of from about 10 to about 60 (U.S. Standard Mesh).

In order to facilitate consolidation of the non-degradable proppant particulates in the proppant slurry into proppant pillars or a proppant pack (in the case of the second embodiment) in accordance with the method disclosed herein, the non-degradable proppant particulates are coated with a consolidating agent. As used herein and in the appended claims, “coated with a consolidating agent” means partially coated or fully coated with the consolidating agent. Any portion of the proppant particulates as a whole may be coated with a consolidating agent. For example, at least a majority of the proppant particulates can be at least partially coated with a consolidating agent and allowed to consolidate in-situ within the formation to form a hardenable permeable or impermeable mass. Any type of consolidating agent that will enable the proppant particulates to consolidate within a fracture in the formation can be used. When the non-degradable proppant particulates of the proppant slurry are coated with a consolidating agent, the proppant particulates can be either pre-coated with the consolidating agent or coated with the consolidating agent on the fly as the proppant slurry is formed and pumped into the wellbore.

For example, the consolidating agent can be selected from the group consisting of a curable resin, a tackifying agent, and mixtures thereof. For example, the consolidating agent can be a curable resin. For example, the curable resin can be selected from the group consisting of epoxies, furans, phenolics, furfuryl aldehydes, furfuryl alcohols, and mixtures thereof. For example, the consolidating agent can be selected from the group consisting of epoxies, furans, phenolics, and mixtures thereof. For example, the consolidating agent can be a tackifying agent. For example, the tackifying agent can be selected from the group consisting of polyamides, polyesters, polycarbonates, natural resins, zeta-potential reducing agents, and mixtures thereof. For example, the tackifying agent can be selected from the group consisting of polyamides, polyesters, polycarbonates, and mixtures thereof.

The consolidating agent facilitates the consolidation of the non-degradable proppant particulates into a plurality of spaced proppant pillars or a proppant pack in the fracture. For example, the size and nature of the proppant pillars or proppant pack can vary depending, in part, upon the specific consolidating agent used and the size of the proppant particulates. In wells with or projected to have high production flow rates, for example, a curable resin may be desirable for use as the consolidating agent to prevent any potential break up of the proppant mass. For example, in wells with or projected to have low production flow rates, it may be desirable to use a tackifying agent as the consolidating agent. In one embodiment, a portion of the non-degradable proppant particulates used in the aqueous based proppant slurry are coated with a curable resin, as stated above, and a portion of the non-degradable proppant particulates used in the aqueous based proppant slurry are coated with a tackifying agent, as stated above.

For example, the non-degradable proppant particulates initially used in the treatment (for example, early in the proppant stage of a fracturing treatment) can be coated with a tackifying agent. At some point during the treatment (for example, the tail-end stage of a fracturing treatment), the non-degradable proppant particulates used can be coated with a curable resin. In another embodiment, the non-degradable proppant particulates can be intermittently coated with a curable resin or a tackifying agent as the aqueous based proppant slurry is injected into the formation on the fly.

In order to increase the permeability of the proppant pack in the second embodiment of the disclosed method and, optionally, in order to increase the permeability of the spaced, proppant pillars in the first embodiment of the disclosed method, the proppant slurry further includes a degradable material, the degradable material including a plurality of degradable food grade particulates. As used herein and in the appended claims, a “food grade particulate” is a particulate that can be consumed by human beings. A “degradable” material such as a “degradable” food grade particulate means a material (or particulate in the case of a degradable food grade particulate) that undergoes a significant irreversible degradation (for example, that chemically breaks down thereby decreasing in terms of size and increasing in terms of solubility) under typical formation conditions.

For example, the degradable material can be added to the proppant slurry in an amount in the range of from about 0.1% to about 30% by weight, based on the weight of the non-degradable proppant particulates in the proppant slurry. For example, the degradable material can be added to the proppant slurry in an amount in the range of from about 0.1% to about 10% by weight, based on the weight of the non-degradable proppant particulates in the proppant slurry. For example, the degradable material can be added to the proppant slurry in an amount in the range of from about 1% to about 5% by weight, based on the weight of the non-degradable proppant particulates in the proppant slurry.

In both embodiments of the disclosed method, the proppant slurry can be pumped into the formation at a pressure above the fracture gradient of the formation such that the cross-linking gelling agent cross-links to form a cross-linked gel and increase the viscosity of the proppant slurry in the formation, and the proppant slurry is placed in the fracture, in any manner known to those skilled in the art of fracturing subterranean formations. Pumping the proppant slurry into the formation at a pressure above the fracture gradient of the formation ensures that the created fracture(s) remains open thereby allowing the proppant slurry to be placed in the fracture.

For example, while the first fracturing fluid is pumped through the annulus between the tubing and casing and through the openings in the casing into the formation, the proppant slurry can be pumped through the tubing and through the openings in the casing into the formation. Alternatively, in the second embodiment of the disclosed method, the proppant slurry can be pumped into the wellbore as a whole, either subsequent to the first fracturing fluid or for the entire fracturing treatment. In this case, a separate tubing and two fluid injection points in the wellbore are not required.

The cross-linkable gelling agent and cross-linker of the proppant slurry and spacer fluid can be any cross-linkable gelling agent and cross-linker known to those skilled in the art to form a cross-linked gel in fracturing fluids and thereby enhance the viscosity of the fluids in the formation. For example, the cross-linkable gelling agent gels the base aqueous fluid (the proppant slurry or spacer fluid) and thereby increases its viscosity. For example, the cross-linker functions to cross link the gel and further thereby further increase the viscosity of the base fluid. For example, the increased viscosity of the base fluid allows the base fluid to transport higher quantities of particulate material. Individuals skilled in the art, with the benefit of this disclosure, will recognize the exact types and amounts of cross-linkable gelling agent and cross-linker to use, depending on factors such as the specific components used, the desired viscosity, and formation conditions.

A variety of cross-linkable gelling agents can be used, including biopolymers, synthetic polymers, or a combination thereof. Examples of suitable cross-linkable gelling agents include hydratable polymers that contain one or more functional groups, such as hydroxyl, carboxyl, sulfate, sulfonate, amino, amide, phosphate, phosphonate, amino, and amide groups. Additional examples of suitable cross-linkable gelling agents include biopolymers that include polysaccharides or derivatives thereof that contain one or more of the following monosaccharide units: galactose, mannose, glucoside, glucose, xylose, arabinose, fructose, glucuronic acid, and pyranosyl sulfate. Additional examples of suitable polymers that can be used as the cross-linkable gelling agents include, but are not limited to, xanthan gum, guar gum and derivatives thereof (such as hydroxypropyl guar and carboxymethylhydroxypropyl guar), and cellulose derivatives (such as hydroxyethyl cellulose). Additionally, synthetic polymers and copolymers that contain the above-mentioned functional groups can be used. Examples of such synthetic polymers include, but are not limited to, polyacrylate, polymethacrylate, polyacrylamide, polyvinyl alcohol, and polyvinylpyrrolidone. As a further example, the cross-linkable gelling agent molecule may be depolymerized. The term “depolymerized,” as used herein, generally refers to a decrease in the molecular weight of the gelling agent molecule.

For example, the cross-linkable gelling agent can be present in the base aqueous solution (the proppant slurry or the spacer fluid) in an amount in the range of from about 0.1% to about 5% by weight, based on the weight of the water in the base fluid. For example, the cross-linkable gelling agents can be present in the base aqueous solution (the proppant slurry or the spacer fluid) in an amount in the range of from about 0.01% to about 2% by weight, based on the weight of the water in the base fluid.

Similarly, a variety of cross-linkers can be used as the cross-linker of the proppant slurry and spacer fluid used in the method disclosed herein. The cross-linker functions to crosslink the cross-linkable gelling agent in the aqueous base fluid to form a cross-linked gel in the base fluid. Suitable cross-linkers comprise at least one metal ion that is capable of crosslinking the cross-linkable gelling agent. Examples include, but are not limited to, borate compounds (such as, for example, alkaline earth metal borates, alkali metal-alkaline earth borates, and mixtures thereof); zirconium compounds (such as, for example, zirconium lactate, zirconium lactate triethanolamine, zirconium carbonate, zirconium acetylacetonate, zirconium malate, zirconium citrate, and zirconium diisopropylamine lactate); titanium compounds (such as, for example, titanium lactate, titanium malate, titanium citrate, titanium ammonium lactate, titanium triethanolamine, and titanium acetylacetonate); aluminum compounds (such as, for example, aluminum lactate or aluminum citrate); antimony compounds; chromium compounds; iron compounds; copper compounds; zinc compounds; and combinations thereof. Further examples of suitable borate compounds include probertite, ulexite, nobleite, frolovite, colemanite, calcined colemanite, priceite, paternoite, hydroboracite, kaliborite, and other similar borates. For example, of the various slightly water-soluble borate compounds that can be used, colemanite, calcined colemanite, and ulexite are good examples. An example of a suitable commercially available borate-based crosslinker is “BC-140™,” a crosslinker available from Halliburton Energy Services, Inc. of Duncan, Okla. An example of a suitable commercially available zirconium-based crosslinker is “CL-24™,” a crosslinker available from Halliburton Energy Services, Inc. of Duncan, Okla. An example of a suitable commercially available titanium-based crosslinking agent is “CL-39™,” crosslinking agent available from Halliburton Energy Services, Inc. of Duncan, Okla.

For example, the cross-linker can be present in the base aqueous solution (the proppant slurry or the spacer fluid) in an amount sufficient to provide, inter alia, the desired degree of crosslinking between the cross-linkable gelling agent molecules. For example, the cross-linker can be present in an amount in the range from about 0.001% to about 10% by weight, based on the weight of the water in the base fluid. For example, the cross-linker can be present in the base solution in an amount in the range from about 0.01% to about 1% by weight, based on the weight of the water in the base solution.

The gel breaker used in the proppant slurry and spacer fluid can be any gel breaker known to those skilled in the art to break a cross-linked gel formed in fracturing fluids and thereby decrease the viscosity of the fluids in the formation. Any suitable gel breaker may be used, including encapsulated gel breakers and internal delayed gel breakers, such as enzyme, oxidizing, acid buffer, or temperature-activated gel breakers. The gel breakers cause the viscous aqueous base fluids to revert to lower viscosity fluids that can be produced back to the surface after they have been used to place proppant particulates and degradable material in the fracture.

For example, the gel breaker can be present in the proppant slurry or spacer fluid in an amount in the range of from about 0.5% to about 10% by weight, based on the weight of the cross-linkable gelling agent. The gel breaker breaks the cross-linked gel into a linear gel or a water-like fluid.

Examples of additional components that can be included in the proppant slurry and spacer fluid used in the disclosed method include a variety of well-known additives, such as gel stabilizers, fluid loss control additives, clay stabilizers, bactericides, and the like.

The cross-linkable, degradable spacer fluid provided in accordance with the first embodiment of the method disclosed herein can be formed on the site of the wellbore including on the fly as it is pumped into the wellbore as the fracturing treatment is carried out. The water of the cross-linkable, degradable spacer fluid can come from a variety of sources. For example, the water can be fresh water, brine salt water, seawater, brackish water, formation water, treated flowback water, and mixtures thereof. Additional components can be included in the cross-linkable, degradable spacer fluid as will be known to those skilled in the art with the benefit of this disclosure.

For example, the degradable material can be used in the cross-linkable, degradable spacer fluid in an amount in the range of from about 10% to about 70% by weight, based on the weight of the water in the spacer fluid. For example, the degradable material can be used in the cross-linkable, degradable spacer fluid in an amount in the range of from about 20% to about 60% by weight, based on the weight of the water in the spacer fluid.

The type and nature of the degradable material included in the proppant slurry provided in accordance with the second embodiment of the method (and optionally included in the proppant slurry provided in accordance with the first embodiment of the disclosed method) and the cross-linkable, degradable spacer fluid provided in accordance with the first embodiment of the disclosed method (the “degradable material”) can be the same or can vary depending on the application. Similarly, the type and nature of the food grade particulates of the degradable material included in the proppant slurry provided in accordance with the second embodiment of the method (and optionally included in the proppant slurry provided in accordance with the first embodiment of the disclosed method) and the cross-linkable, degradable spacer fluid provided in accordance with the first embodiment of the disclosed method (the “degradable food grade particulates”) can be the same or can vary depending on the application.

For example, the degradable food grade particulates can have a mesh size in the range of from 10 to 80 (U.S. Standard Mesh). For example, the degradable food grade particulates can have a size in the range of from about 10 to about 50 (U.S. Standard Mesh). For example, the degradable food grade particulates can have a size in the range of from about 20 to about 40 (U.S. Standard Mesh).

For example, the degradable food grade particulates can be grains. The grains can be selected from the group consisting of whole grains, partially crushed grains, powders of grain, and mixtures thereof.

For example, the grains can be selected from the group consisting of grains of millet, grains of sorghum, grains of maize, and mixtures thereof. For example, the grains can be grains of millet. For example, the grains of millet can be selected from the group consisting of finger millet, grains of pearl millet, grains of proso millet and mixtures thereof.

For example, finger millet (Eleusine coracana) is an annual plant widely grown as a cereal in the arid areas of Africa and Asia. It is sometimes referred to as African finger millet, red millet, caracan millet, koracan and ragi. Finger millet is native to the Ethiopian Highlands. It is very adaptable to higher elevations and is grown in the Himalaya up to 2300 meters in elevation.

When powdered, particulates of the husk of finger millet (the external covering) are less soluble in water than particulates of the millet itself. Due to this difference in solubility, finger millet can be used to form a non-uniform mixture of particulates in water. Finger millet is friendly to the environment, and it is cost effective due to its abundance. Moreover, it can be used up to a temperature of at least 200° F., and is easily dispersed in treating fluids.

The type and specific features of the degradable food grade particulates can be selected or modified to provide degradable food particulates having a desired degradation time. Also, for example, the degradable food grade particulates used in the aqueous based proppant slurry can be selected or formed to have a size and shape similar to the size and shape of the non-degradable proppant particulates of the aqueous based proppant slurry in order to maintain substantial uniformity within the slurry.

For example, the degradable food grade particulates can include one or more degradable components in addition to the degradable food grade particulates. For example, if desired, the degradable material may also include man-made degradable particulates such as degradable polymers.

For example, in the second embodiment of the method (and when a degradable material including food grade particulates are added to the proppant slurry in the first embodiment of the method), the non-degradable proppant particulates can be coated with a consolidating agent prior to being mixed with the degradable material of the proppant slurry. For example, the aqueous based proppant slurry can be formed by:
(a) coating the non-degradable proppant particulates with the consolidating agent;
(b) suspending the coated non-degradable particulates in an aqueous medium; and
(c) blending the degradable food grade particulates with the coated non-degradable proppant particulates in the aqueous medium to form a homogenous slurry of the coated non-degradable proppant particles and the degradable food grade particulates.

If desired, one or both of the spacer fluid and the proppant slurry (for example, if the proppant slurry further includes a degradable material) used in the first embodiment of the disclosed method, and the proppant slurry used in the second embodiment of the method, can further include a breaker for the degradable material to facilitate degradation of the degradable material. The use of a breaker to facilitate degradation of the degraded material helps ensure that the degraded material is removed and does not damage the permeability of the formation.

Alternatively to or in addition to including a breaker for the degradable material in the proppant slurry and/or spacer fluid, a breaker for the degradable material (whether as part of the proppant slurry, the spacer fluid, or both) can be pumped into the formation after the proppant slurry (and spacer fluid in the first embodiment) has been placed in the fracture in order to facilitate degradation of the degradable material. For example, the breaker for the degradable material can be added to an aqueous base fluid (for example, water) and pumped into the formation therewith. Pumping the breaker for the degradable material into the formation only as a post fluid flush may be desirable, for example, in the event that the breaker for the degradable material is not compatible with another component used in the method.

An example of a suitable breaker for the degradable material that can be added to the proppant slurry and spacer fluid and used as part of a post flush fluid, as appropriate, is a breaker fluid that includes an organic acid component and an oxidizer component. The organic acid component can be any water-soluble organic acid or source of a water-soluble organic acid, wherein the water-soluble organic acid has a pKa in the range of 1 to 5. Specific examples of organic acids that can be used as the organic acid component include formic acid (pKa=3.77), acetic acid (pKa=4.79), and mixtures thereof. For example, the organic acid component of the breaker for the degradable material can be formic acid, which is commercially available as a concentrated liquid. The oxidizer component of the breaker can be any water-soluble oxidizer or source of a water-soluble oxidizer. Specific examples of oxidizers that can be used include peroxides such as tert-butyl hydrogen peroxide, chlorites, hypochlorites, chlorates, perchlorates, other analogous halogen compounds, perborates, and peroxides, and mixtures thereof. For example, the oxidizer component of the breaker fluid can be a peroxide.

An example of another breaker for the degradable material that can be added to the proppant slurry and spacer fluid and used as part of a post flush fluid, as appropriate, is ammonium persulphate that has been coated with an organic material. For example, ammonium persulphate coated with silica can be used.

If desired, the breaker for the degradable material that can be added to the proppant slurry and spacer fluid and used as part of a post flush fluid, as appropriate, can be encapsulated to help slow down its activity or to isolate its activity and prevent the breaker from impacting the aqueous base fluid (for example, the proppant slurry or spacer fluid) that carries the breaker package to the formation and places it in the fracture. For example, encapsulating the breaker can provide more control over the time it takes the food grade particulates to degrade. The encapsulating material can be anything that will slowly release the breaker components over the desired period of time.

An example of a suitable encapsulated breaker that can be used is sold by Halliburton Energy Services under the trade name OPTIFLO III™ and includes ammonium persulphate coated with silica material. In use, the silica coating slowly disintegrates in water thereby slowly releasing the encapsulated ammonium persulphate. For example, tests of the use of OPTIFLO III™ breaker to degrade a millet material provided the following results:

| Breaker | Concentration | Degradation |
|---|---|---|
| OPTIFLO III ™ | 50 ppt | 80% in 7 days |

For example, when the organic acid/oxidizer breaker system discussed above is used as the breaker for the degradable material, about 10 to about 20 gallons of the organic acid component and about 5 to about 15 gallons of the oxidizer component can be used for every thousand gallons of water included in the base fluid (the proppant slurry, spacer fluid and/or post flush fluid). For example, when the organic acid/oxidizer breaker system discussed above is used as the breaker for the degradable material, about 15 gallons of the organic acid component and about 10 gallons of the oxidizer component can be used for every thousand gallons of water included in the base fluid (the proppant slurry or the spacer fluid).

The cross-linkable, degradable spacer fluid provided in accordance with the first embodiment of the disclosed method can be pumped into the formation at a pressure above the fracture gradient of the formation while pumping the proppant slurry into the formation in any manner known to those skilled in the art of fracturing subterranean formations. As the spacer fluid and proppant slurry are pumped into the formation, the cross-linkable gel cross-links and increases the viscosity of the spacer fluid and the spacer fluid separates and spaces the non-degradable proppant particulates within the proppant slurry.

For example, the spacer fluid can be substituted for the first fracturing fluid being pumped through the annulus between the tubing and casing and through the openings in the casing into the formation while the proppant slurry is pumped through the tubing in the wellbore and through the openings in the casing into the formation. Pumping the spacer fluid through the annulus between the tubing and the casing at a pressure above the fracture gradient continues helps ensure that the fracture remains open as necessary during the fracturing treatment.

The cross-linked gel formed in the proppant slurry and spacer fluid is allowed to break down thereby decreasing the viscosity of the proppant slurry and spacer fluid in the formation by allowing sufficient time for the gel breaker in the proppant slurry and spacer fluid to break the gel and the gel to be broken down.

The non-degradable proppant particulates in the proppant slurry can be allowed to consolidate into a plurality of spaced proppant pillars in the fracture in accordance with the first embodiment of the method disclosed herein, and into a proppant pack in the fracture in accordance with the second embodiment of the method disclosed herein, by allowing a sufficient time for the proppant pillars or proppant pack to form before the fracture is allowed to close. For example, a sufficient time is allowed for the consolidating agent to act. For example, if a curable resin is used as the consolidating agent, it functions to consolidate non-degradable particulates and hold them together within the fracture as it cures within the fracture. If a tackifying agent is used, it causes non-degradable particulates to cling together within the fracture.

The pressure within the formation can be allowed to fall below the fracture gradient in both embodiments of the disclosed method by releasing or decreasing the hydraulic pressure created on the formation. For example, pumping of the hydraulic pressure-creating fluid into the formation can be stopped, or the rate at which the hydraulic pressure-creating fluid is pumped into the formation can be sufficiently decreased to allow the fracture to close. Allowing the pressure within the formation to fall below (including significantly below) the fracture gradient of the formation typically causes the fracture to close on top of the proppant pillars or proppant pack in the formation.

The degradable material used in the spacer fluid used in the first embodiment of the method, optionally used in the proppant slurry used in the first embodiment of the method and used in the proppant slurry used in the second embodiment of the method is allowed to degrade by allowing sufficient time for the breaker for the degradable material (whether included as part of the proppant slurry and/or spacer fluid or pumped into the formation as a post fluid flush) to facilitate degradation of the degradable material and the degradable material to degrade. For example, the degradable food grade particulates used in connection with the degradable material can be allowed to generally remain intact until the proppant pillars (or proppant pack in the case of the second embodiment) have developed substantial compression strength or stability within the fracture in order to minimize shifting or rearrangement of proppant particulates within the pillars.

Degradation of the degradable material (including the degradable food grade particulates) of the proppant slurry allows the material to be substantially removed from the proppant pillars or proppant pack (in the case of the second embodiment) of the method. As a result, voids and/or channels are created in the proppant pillars or proppant pack, which increases the permeability of the proppant pillars or proppant pack. The increased permeability of the proppant pillars or proppant pack results in enhanced fracture conductivity and increased well productivity.

Similarly, degradation of the degradable material (including the degradable food grade particulates) of the cross-linkable, degradable spacer fluid allows the material to be substantially removed from the portions of the fracture surrounding the spaced proppant pillars. As a result, proppant-free channels are created in the fracture, which also results in enhanced fracture conductivity and increased well productivity. As used herein and in the appended claims, the term “proppant free channel” refers to a channel in the formation that is free of proppant or does not contain a sufficient amount of proppant to block the flow of production fluids through the channel.

The broken gels in the proppant slurry and spacer fluid (in the first embodiment) and the degraded material can then be removed from the fracture by slowly flowing back the well. For example, the initial stage of production can be carried out in increasing step rates.

In accordance with the disclosed method, the permeability of the proppant pillars (proppant pack in the second embodiment) can be increased and proppant free channels can be formed (in the first embodiment) without impacting the ability of the proppant pillars or proppant pack to perform as intended, for example, without inhibiting the ability of the proppant pillars or proppant pack to keep the fracture open. The degradable food grade particulates used as or in connection with the degradable material of the aqueous based proppant slurry are readily available, non-toxic, relatively inexpensive (for example, compared to PLA polymers and other man-made degradable particulates) and can be easily modified to meet degradation time requirements.

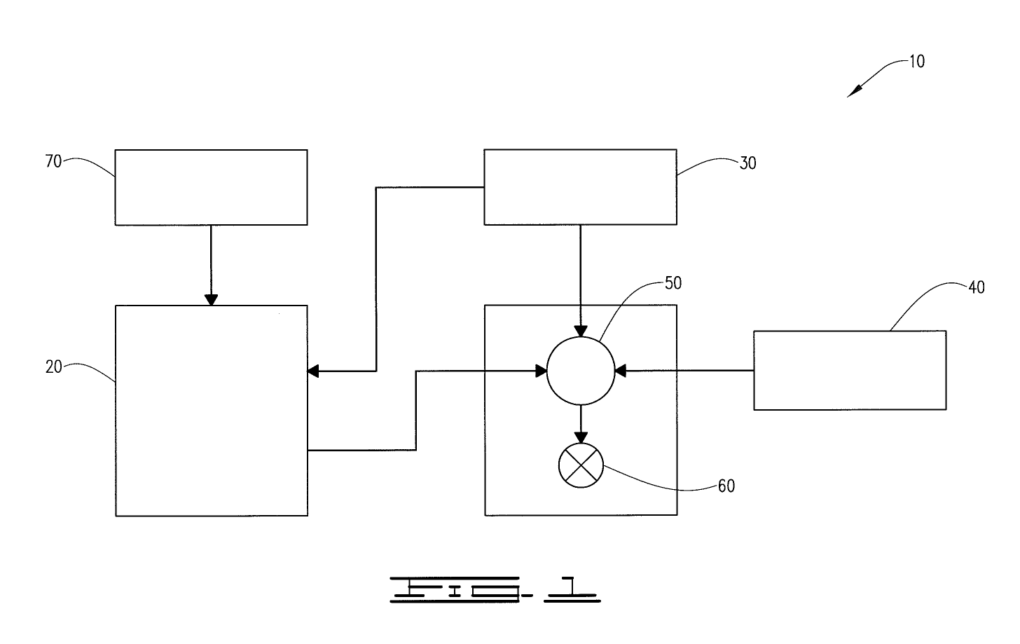

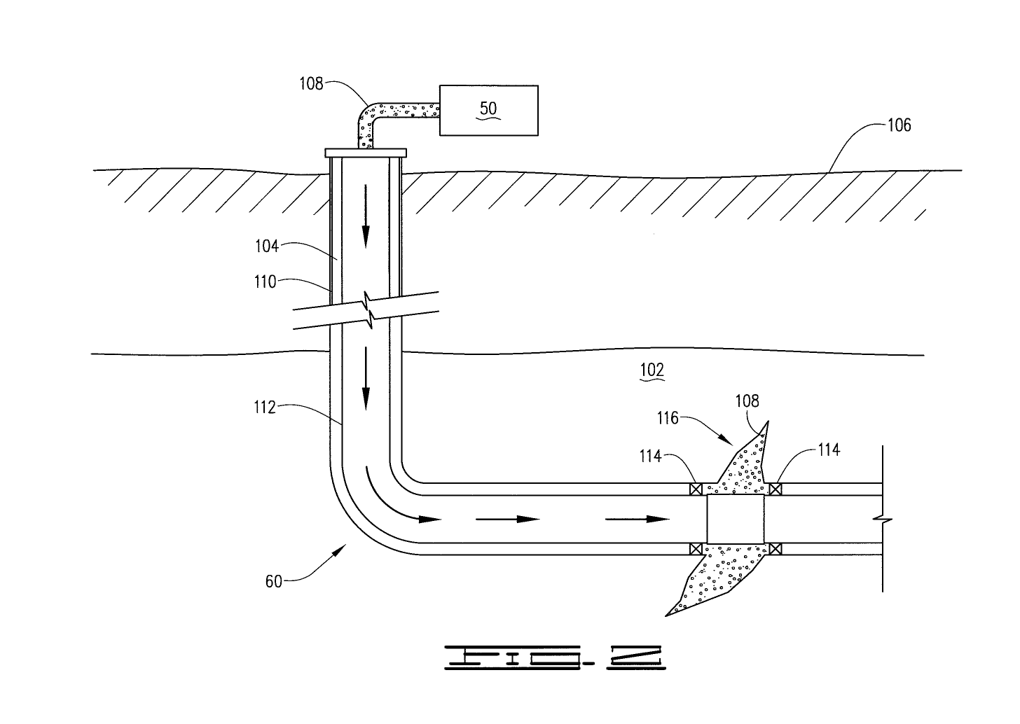

The exemplary fluids, compositions and methods disclosed herein may directly or indirectly affect one or more components or pieces of equipment associated with the preparation, delivery, recapture, recycling, reuse, and/or disposal of the disclosed fluids, compositions and methods. FIGS. 1 and 2 illustrate a typical fracturing operation.

For example, and with reference to FIG. 1, the disclosed fluids, compositions and methods may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include and provide the proppant for combination with the fracturing fluid. The system may also include an additive source 70 that provides one or more additives (e.g., gelling agents, weighting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

For example, the pump and blender system 50 can receive the fracturing fluid and combine it with other components, including proppant particulates from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppant particulates, and/or other compositions to the pumping and blender system 50. Such metering devices may permit the pumping and blender system 50 to source from one, some or all of the different sources at a given time, and may facilitate the preparation of fracturing fluids in accordance with the present disclosure using continuous mixing or “on the fly” methods. Thus, for example, the pumping and blender system 50 can provide just fracturing fluid into the well at some times, just proppant slurry at some times, just proppant particulates at other times, and combinations of those components at yet other times.

FIG. 2 shows the well 60 during a fracturing operation in a portion of a subterranean formation of interest 102 surrounding a wellbore 104. The wellbore 104 extends from the surface 106, and the fracturing fluid 108 is applied to a portion of the subterranean formation 102 surrounding the horizontal portion of the wellbore. Although shown as vertical deviating to horizontal, the wellbore 104 may include horizontal, vertical, slant, curved, and other types of wellbore geometries and orientations, and the fracturing treatment may be applied to a subterranean zone surrounding any portion of the wellbore. The wellbore 104 can include a casing 110 that is cemented or otherwise secured to the wellbore wall. The wellbore 104 can be uncased or include uncased sections. Perforations can be formed in the casing 110 to allow fracturing fluids and/or other materials to flow into the subterranean formation 102. In cased wells, perforations can be formed using shaped charges, a perforating gun, hydro jetting and/or other tools.

The well is shown with a work string 112 depending from the surface 106 into the wellbore 104. The pump and blender system 50 is coupled to a work string 112 to pump the fracturing fluid 108 into the wellbore 104. The work string 112 may include coiled tubing, jointed pipe, and/or other structures that allow fluid to flow into the wellbore 104. The work string 112 can include flow control devices, bypass valves, ports, and or other tools or well devices that control a flow of fluid from the interior of the working string 112 into the subterranean zone 102. For example, the work string 112 may include ports adjacent the wellbore wall to communicate the fracturing fluid 108 directly into the subterranean formation 102, and/or the work string 112 may include ports that are spaced apart from the wellbore wall to communicate the fracturing fluid 108 into an annulus in the wellbore between the working string 112 and the wellbore wall.

The work string 112 and/or the wellbore 104 may include one or more sets of packers 114 that seal the annulus between the work string 112 and wellbore 104 to define an interval of the wellbore 104 into which the fracturing fluid 108 will be pumped. FIG. 2 shows two packers 114, one defining an uphole boundary of the interval and one defining the downhole end of the interval. When the fracturing fluid 108 is introduced into wellbore 104 (e.g., in FIG. 2, the area of the wellbore 104 between packers 114) at a sufficient hydraulic pressure, one or more fractures 116 may be created in the subterranean zone 102. The non-degradable proppant particulates in the fracturing fluid 108 enter the fractures 116 where they may remain after the fracturing fluid flows out of the wellbore, as described above. These proppant particulates may “prop” fractures 116 such that fluids may flow more freely through the fractures 116.

While not specifically illustrated herein, the disclosed fluids, compositions and methods may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

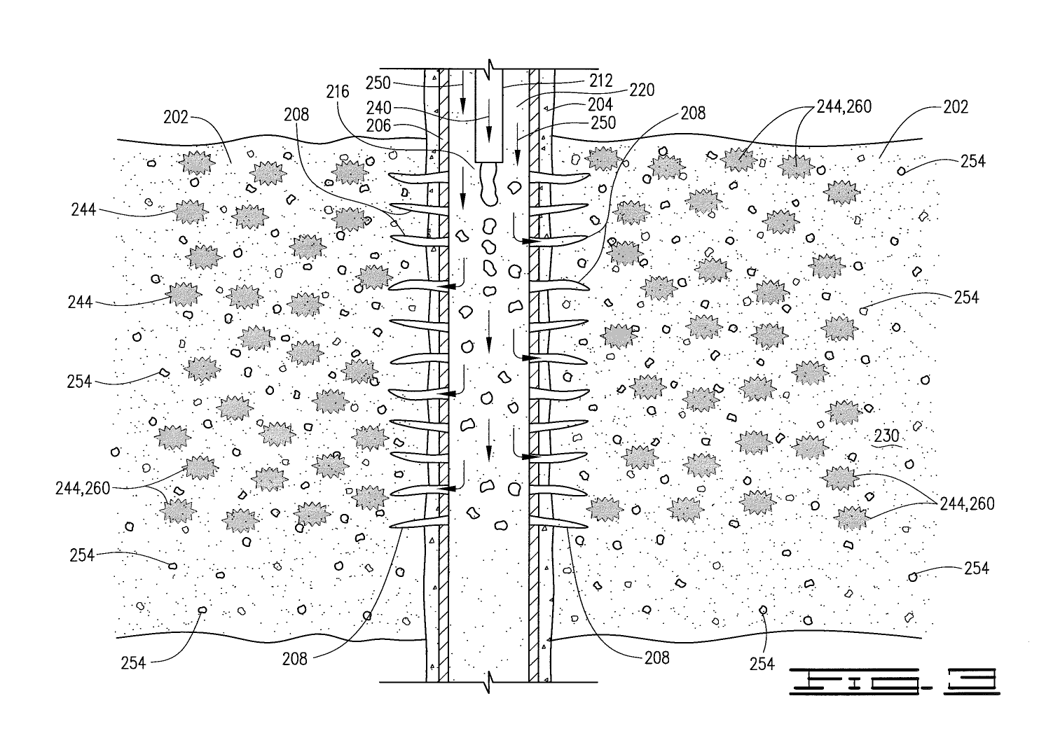

Referring now to FIGS. 3-6, certain aspects the first and second embodiments of the disclosed method are more specifically illustrated.

FIG. 3 illustrates the first embodiment of the disclosed method at one stage of the method. As shown, a subterranean formation 202 is penetrated by a wellbore 204 surrounded by a casing 206 having a plurality of perforations or openings 208 therein adjacent to the formation. A coiled tubing 212 extends through the wellbore 204 to a point 216 adjacent to the openings 208 in the casing 206 such that an annulus 220 is formed between the tubing and the casing.

As shown by FIG. 3, a fracture 230 has been created in the formation 202. A proppant slurry 240 containing a plurality of non-degradable proppant particulates 244 is being pumped through the coiled tubing 212 and through the openings 208 in the casing 206 into the formation 202 and into the fracture 230. At the same time, a cross-linkable, degradable spacer fluid 250 containing a plurality of degradable food grade particulates 254 is being pumped through the annulus 220 and through the openings 208 in the casing 206 into the formation and into the fracture 230. As shown the spacer fluid 250 including the degradable food grade particulates 254 separates and spaces the non-degradable proppant particulates 244 within the fracture. The non-degradable proppant particulates 244 have consolidated into a plurality of spaced proppant pillars 260 in the fracture.

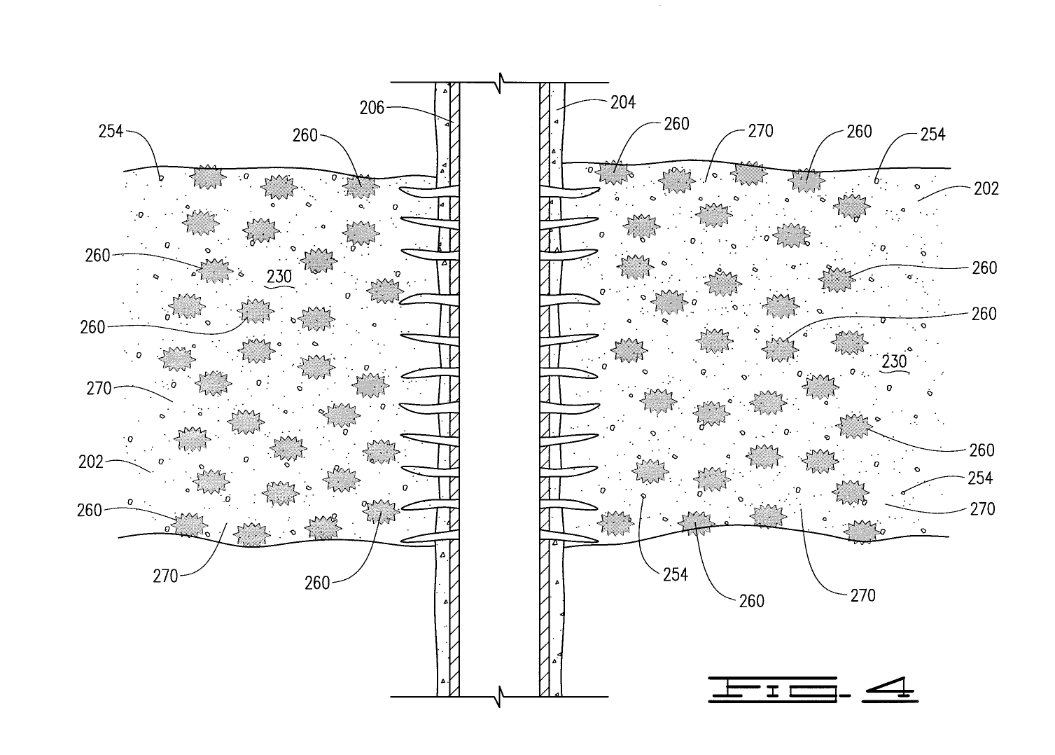

FIG. 4 illustrates the embodiment of the method shown by FIG. 1, but at a later stage of the method. As shown by FIG. 4, all pumping, including pumping of the proppant slurry and pumping of the spacer fluid has ceased. At this point, the fracture is held open by the spaced proppant pillars 260. The degradable food grade particulates 254 have significantly degraded thereby beginning the formation of proppant-free channels 270.

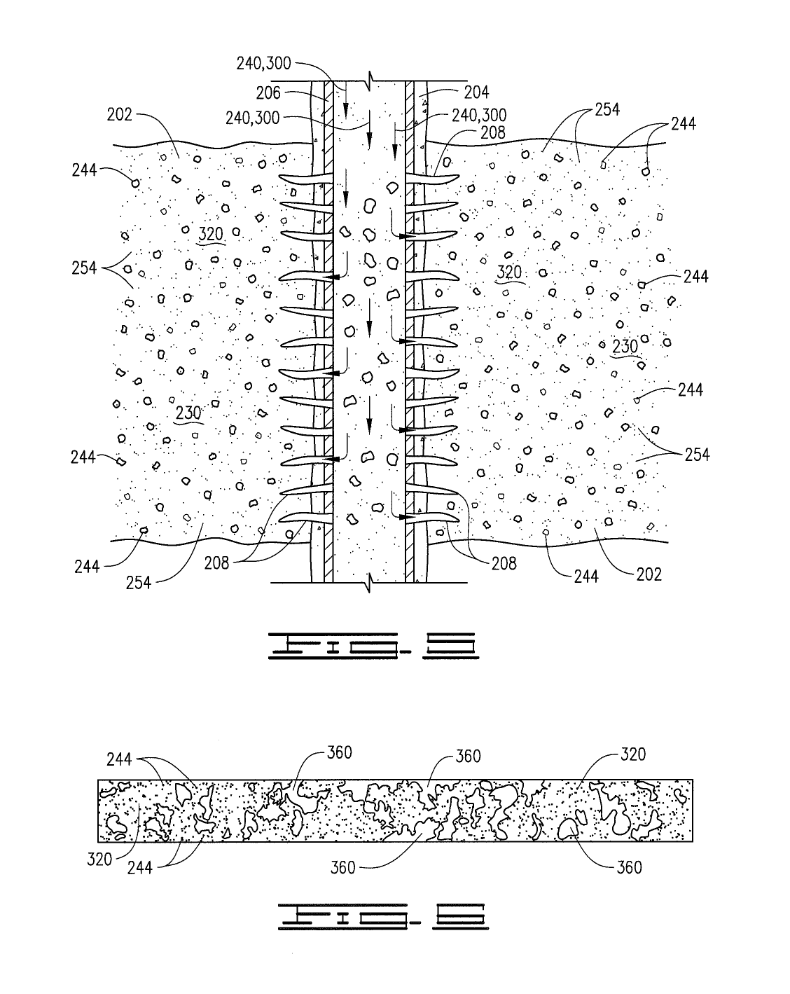

FIG. 5 illustrates the second embodiment of the disclosed method. As shown by FIG. 5, a first fracturing fluid 300 is pumped into the formation 202 through the wellbore 204 and through the openings 208 in the casing 206 at a pressure above the fracture gradient of the formation to create a fracture 230 in the formation. After the fracture has been created, a proppant slurry 240 including a plurality of non-degradable proppant particulates 244 and a degradable material (including a plurality of degradable food grade particulates 254) is pumped into the formation 202 and fracture 230 through the wellbore 204 and through the openings 208 in the casing 206. Alternatively, the first fracturing fluid 300 can be eliminated and the proppant slurry 240 can be used to create the fracture and carry the non-degradable proppant particulates and food grade particulates to the fracture. As shown, the non-degradable proppant particulates 244 in the proppant slurry 240 have been allowed to consolidate into a proppant pack 320 in the fracture.

FIG. 6 illustrates what the proppant pack 320 shown by FIG. 4 looks like after fluid pumping has ceased and the degradable material, including the degradable food grade particulates 254, have significantly degraded. As shown, the proppant pack 320 now includes a plurality of permeable portions 360 where food grade particulates 254 were once in tact.

### EXAMPLES

The following examples illustrate specific embodiments consistent with the present disclosure but do not limit the scope of the disclosure or the appended claims. Concentrations and percentages are by weight unless otherwise indicated.

### Example 1

Approximately 5 grams of whole grain finger millet were mixed with a breaker package in 250 ml of water. The breaker package included formic acid and tertiary butyl hydrogen peroxide in the concentrations shown by Table 2 below:

### Table 2

### Breaker Package

TABLE 2
Breaker Package

| Breaker | Concentration |
|---|---|
| Formic acid | 15 gpt* (liquid) |
| Tertiary butyl hydrogen peroxide | 10 gpt (liquid) |

*grams per teaspoon (i.e., grams of the stated component per teaspoon of water)

After 13 days, the weight of the remaining finger millet was determined by extracting the remaining finger millet particles with filter paper, drying the particles and weighing the particles. At this point, only 0.95 grams of finger millet remained. This shows that 4.05 grams of the sample were degraded yielding a percent of degradation of 81%.

### Example 2

In this example, 5 grams of whole grain finger millet were partially crushed in the lab by using a mortar grinder. The crushed pieces had an approximate average diameter of 0.5 mm.

Next, the 5 gram sample of partially crushed finger millet was mixed with a breaker package in 250 ml of water. The breaker package was the same as the breaker package (including the concentrations) shown in Table 1.

After approximately 11 days, the weight of the remaining finger millet particles was determined by extracting the particles with filter paper, drying the particles, and weighing the particles. At this point, only 0.712 grams of finger millet was recovered indicating that approximately 4.288 grams of the finger millet had degraded yielding a percent of degradation of 85.77.

### Example 3

In this example, approximately 5 grams of whole grain finger millet were ground into powder form in the lab by using a mortar grinder. The average diameter of the powder particles was less than about 150 microns. Next, the 5 gram sample of the finger millet powder was mixed with a breaker package in 250 ml of water. The breaker package was the same as the breaker package (including the concentrations) shown in Table 1. The mixture was then placed in an oven and maintained at approximately 150° F. for approximately 7 days.

After the 7 day test period, the weight of the finger millet was determined by extracting the powder particles with filter paper, drying the particles, and weighing the particles. At this time, only 1.152 grams of finger millet powder were recovered, indicating that the amount of the sample degraded was 4.339 grams yielding a percent of degradation of 86.79.

### Example 4

In this example, approximately 5 grams of sorghum bicolor grain were partially crushed in the laboratory by using a mortar grinder. The crushed pieces had an approximate average diameter of 1 mm.

Next, the partially crushed 5 gram sorghum sample was mixed with a breaker package in 250 ml of water. The breaker package was the same as the breaker package (including the concentrations) shown in Table 1.

After approximately 11 days, the weight of the sorghum was determined by extracting the particles with filter paper, drying the particles, and weighing the particles. At this point, only 0.911 grams of the sorghum were recovered, indicating that the amount of the sample degraded was 4.089 grams yielding a percent of degradation of 81.79.

Therefore, the present compositions and methods are well adapted to attain the ends and advantages mentioned, as well as those that are inherent therein. The particular examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A method of fracturing, a subterranean formation, comprising:
(a) creating at least one fracture in the formation by pumping a fluid into the formation at a pressure above the fracture gradient of the formation;
(b) providing an aqueous based proppant slurry, said proppant slurry including water, a cross-linkable gelling agent, a cross-linker, a gel breaker, and a plurality of non-degradable proppant particulates, said non-degradable proppant particulates being coated with a consolidating agent;
(c) pumping said proppant slurry into the formation at a pressure above the fracture gradient of the formation such that said cross-linking gelling agent cross-links to form a cross-linked gel and increase the viscosity of said proppant slurry, and said proppant slurry is placed in said fracture;
(d) providing a cross-linkable, degradable spacer fluid, said spacer fluid including water, a cross-linkable gelling agent, a cross-linker, a gel breaker, and a degradable material, said degradable material including a plurality of degradable food grade particulates;
(e) while pumping said proppant slurry into the formation in accordance with step (c), pumping said spacer fluid into the formation at a pressure above said fracture gradient of the formation such that said cross-linkable gelling agent cross-links to form a cross-linked gel and increase the viscosity of said spacer fluid, and said spacer fluid separates and spaces said non-degradable proppant particulates within said fracture;
(f) allowing said cross-linked gel to break down thereby decreasing the viscosity of said proppant slurry and spacer fluid;
(g) allowing said non-degradable proppant particulates in said proppant slurry to consolidate into a plurality of spaced proppant pillars in said fracture;
(h) allowing the pressure within the fracture to fall below said fracture gradient of the formation;
(i) allowing said degradable material to degrade; and
(j) flowing back the well to remove the broken gels in said proppant slurry and spacer fluid and the degraded material from the fracture thereby forming proppant-free channels in said fracture.

2. The method of claim 1, wherein said non-degradable proppant particulates are selected from the group of sand, fly ash, silica flour, walnut hulls, resin pre-coated proppant particulates, man-made non-degradable proppant particulates, and mixtures thereof.

3. The method of claim 1, wherein said consolidating agent is selected from the group of a curable resin, a tackifying agent, and mixtures thereof.

4. The method of claim 1, wherein said proppant slurry further includes a degradable material, said degradable material including a plurality of degradable food grade particulates.

5. The method of claim 4, wherein one or both of said proppant slurry and said spacer fluid further include a breaker for said degradable material.

6. The method of claim 1, further comprising pumping a breaker for said degradable material into the formation.

7. The method of claim 1, wherein said food grade particulates are grains.

8. The method of claim 7, wherein said grains are selected from the group of grains of millet, grains of sorghum, grains of maize, and mixtures thereof.

9. The method of claim 8, wherein said grains are grains of millet.

10. A method of fracturing a subterranean formation penetrated by a wellbore having a casing comprising one or more openings therein adjacent to the formation, comprising:
(a) creating at least one fracture in the formation by pumping a first fracturing fluid into the formation through the openings in the casing at a pressure above the fracture gradient of the formation, said first fracturing fluid being free of proppant particulates and degradable particulate material;
(b) providing an aqueous based proppant slurry, said proppant slurry including water, a cross-linkable gelling agent, a cross-linker, a gel breaker, a plurality of non-degradable proppant particulates, and a degradable material, wherein said non-degradable proppant particulates are coated with a consolidating agent and said degradable material includes a plurality of degradable food grade particulates;
(c) pumping said proppant slurry into the formation through the openings in the casing at a pressure above the fracture gradient of the formation such that said cross-linking gelling agent cross-links to form a cross-linked gel and increase the viscosity of said proppant slurry, and said proppant slurry is placed in said fracture;
(d) providing a cross-linkable, degradable spacer fluid, wherein said spacer fluid comprises water, a cross-linkable gelling agent, a cross-linker, a gel breaker, and a degradable material, and wherein said degradable material comprises a plurality of degradable food grade particulates;
(e) while pumping said proppant slurry into the formation in accordance with step (c), pumping said spacer fluid into the formation through the openings in the casing, said spacer fluid being pumped into said formation at a pressure above said fracture gradient such that said cross-linkable gelling agent cross-links to form a cross-linked gel and increase the viscosity of said spacer fluid, and said spacer fluid separates and spaces said non-degradable proppant particulates within said fracture;
(f) allowing said cross-linked gel in said proppant slurry and spacer fluid to break down hereby decreasing the viscosity of said proppant slurry and spacer fluid;
(g) allowing said non-degradable proppant particulates in said proppant slurry to consolidate into a plurality of spaced proppant pillars in said fracture;
(h) allowing the pressure within the formation to fall below said fracture gradient of the formation;
(i) allowing said degradable material of said spacer fluid and said degradable material of said proppant slurry to degrade; and
(j) flowing back the well to remove the broken gels in said proppant slurry and spacer fluid and the degraded material from the fracture thereby forming proppant-free channels in said fracture.

11. The method of claim 10, wherein said non-degradable proppant particulates are selected from the group of sand, fly ash, silica flour, walnut hulls, resin pre-coated proppant particulates, man-made non-degradable proppant particulates, and mixtures thereof.

12. The method of claim 10, wherein said consolidating agent is selected from the group of a curable resin, a tackifying agent, and mixtures thereof.

13. The method of claim 10, wherein one or both of said proppant slurry and said spacer fluid further include a breaker for said degradable material.

14. The method of claim 10, further comprising pumping a breaker for said degradable material into the formation.

15. The method of claim 10, wherein said food grade particulates of said proppant slurry and said spacer fluid are grains.

16. The method of claim 15, wherein said grains are selected from the group of grains of millet, grains of sorghum, grains of maize, and mixtures thereof.

17. The method of claim 16, wherein said grains are grains of millet.

18. A method of fracturing a subterranean formation penetrated by a wellbore surrounded by a casing having one or more openings therein adjacent to the formation, comprising:
(a) creating at least one fracture in the formation by pumping a fluid into the formation at a pressure above the fracture gradient of the formation;
(b) providing an aqueous based proppant slurry, said proppant slurry including water, a cross-linkable gelling agent, a cross-linker, a gel breaker, a plurality of non-degradable proppant particulates, and a degradable material, said non-degradable proppant particulates being coated with a consolidating agent, and said degradable material including a plurality of degradable food grade particulates;
(c) pumping said proppant slurry into the formation at a pressure above the fracture gradient of the formation such that said cross-linking gelling agent cross-links to form a cross-linked gel and increase the viscosity of said proppant slurry, and said proppant slurry is placed in said fracture;
(d) allowing said cross-linked gel to break down thereby decreasing the viscosity of a proppant slurry;
(e) allowing said non-degradable proppant particulates to consolidate into a proppant pack in said fracture;
(f) allowing the pressure within the fracture to fall below said fracture gradient of the formation;
(g) allowing said degradable material of said proppant slurry to degrade; and
(h) flowing back the well to remove the broken gel in said proppant slurry and degraded material from the fracture thereby increasing the permeability of said proppant pack.

19. The method of claim 18, wherein said non-degradable proppant particulates are selected from the group of sand, fly ash, silica flour, walnut hulls, resin pre-coated proppant particulates, man-made non-degradable proppant particulates, and mixtures thereof.

20. (canceled)

21. (canceled)

22. (canceled)

23. (canceled)

24. (canceled)

25. The method of claim 18, further comprising forming said aqueous based proppant slurry using mixing equipment.
